(19) United States
(12) Patent Application Publication
(10) Pub. No.: US 2016/0055003 A1
(43) Pub. Date: Feb. 25, 2016

(54) BRANCH PREDICTION USING LEAST-RECENTLY-USED (LRU)-CLASS LINKED LIST BRANCH PREDICTORS, AND RELATED CIRCUITS, METHODS, AND COMPUTER-READABLE MEDIA

(71) Applicant: QUALCOMM Incorporated, San Diego, CA (US)

(72) Inventors: Robert Douglas Clancy, Cary, NC (US); Michael Scott McIlvaine, Raleigh, NC (US); Spencer Ellis Williams, Raleigh, NC (US)

(21) Appl. No.: 14/490,905

(22) Filed: Sep. 19, 2014

Related U.S. Application Data
(60) Provisional application No. 62/038,926, filed on Aug. 19, 2014.

(51) Int. Cl. G06F 9/38; G06F 12/08; G06F 12/12

(52) U.S. Cl. CPC G06F 9/3861; G06F 12/122; G06F 9/3867; G06F 12/0875; G06F 2212/69; G06F 2212/452

(57) ABSTRACT

Branch prediction using Least-Recently-Used (LRU)-class linked list branch predictors, and related circuits, methods, and computer-readable media are disclosed. In one aspect, a branch predictor circuit comprises branch direction prediction logic and a linked list comprising a plurality of predictor entries, each comprising a link address register. The branch predictor circuit also comprises a LRU indicator indicative of a relative age of each of the predictor entries. The branch predictor circuit is configured to detect a first branch instruction in an instruction stream, and determine whether the first branch instruction is predicted to be taken. Responsive to determining that the first branch instruction is predicted to be taken, the branch predictor circuit allocates a least-recently-used entry of the plurality of predictor entries of the linked list based on the LRU indicator, and stores a sequential address for the first branch instruction in the link address register of the least-recently-used predictor entry.

### PRIORITY CLAIM

The present application claims priority to U.S. Provisional Patent Application Ser. No. 62/038,926 filed on Aug. 19, 2014 and entitled “BRANCH PREDICTION USING PSEUDO-LEAST-RECENTLY-USED (PLRU)-BASED LINKED LIST BRANCH PREDICTORS, AND RELATED CIRCUITS, METHODS, AND COMPUTER-READABLE MEDIA,” which is incorporated herein by reference in its entirety.

### BACKGROUND

I. Field of the Disclosure

The technology of the disclosure relates generally to branch prediction for instructions executed in a pipelined computer processor.

II. Background

Instruction pipelining is a processing technique whereby the throughput of computer instructions being executed by a processor may be increased by splitting the handling of each instruction into a series of steps. These steps are executed in an execution pipeline composed of multiple stages. Optimal processor performance may be achieved if all stages in an execution pipeline are able to process instructions concurrently. However, concurrent execution of instructions in an execution pipeline may be hampered by the presence of conditional branch instructions. Conditional branch instructions may redirect the flow of a program based on conditions evaluated when the conditional branch instructions are executed. As a result, the processor may have to stall the fetching of additional instructions until a conditional branch instruction has executed, resulting in reduced processor performance and increased power consumption.

One approach for maximizing processor performance involves utilizing a branch direction predictor circuit to predict whether a conditional branch instruction will be taken. The prediction of whether a conditional branch instruction will be taken can be based on branch prediction history of previous conditional branch instructions. Instructions corresponding to the predicted branch may then be fetched and speculatively executed by the processor. In the event of a mispredicted branch, the processor may incur a delay while the speculatively fetched instructions corresponding to the mispredicted branch are flushed from the execution pipeline, and the correct instructions are fetched.

Processor performance may be further maximized by utilizing a branch target prediction circuit to predict the target address of indirect branches. Subroutine return branch instructions are a specific form of indirect branches. Subroutine call and return branch instruction pairs are generally used in conjunction with a stack-based subroutine call standard. As a result, many conventional computer processors employ stack-based branch predictors. A stack-based branch predictor records a branch return address when a subroutine call branch instruction is observed (e.g., by using a PUSH operation to place the branch return address onto a stack). The stack-based branch predictor may then restore the branch return address as a target address prediction in a Last-In-First-Out (LIFO) order when a subroutine return branch instruction is observed (e.g., by using a POP operation to remove the branch return address from the stack).

However, conventional stack-based branch predictors are susceptible to corruption arising from speculative call and return branches. For example, a first subroutine call to subroutine A that is predicted to be taken results in the branch return address for subroutine A being placed in a stack. Based on the predicted execution of instructions in subroutine A, a subroutine return branch instruction for subroutine A is eventually encountered, and the branch return address for subroutine A is removed from the stack. A second subroutine call for subroutine B, also predicted to be taken, then causes the branch return address for subroutine B to be placed in the stack. If, at this point, it is determined that the execution flow within subroutine A was mispredicted, execution is rolled back to a point before the subroutine return branch instruction for subroutine A. When the subroutine return branch instruction for subroutine A is subsequently encountered in the corrected instruction stream, the branch return address for subroutine A is no longer available, as it has been overwritten in the stack with the branch return address for subroutine B. Similarly, issues may arise if the subroutine call to subroutine B is predicted not to be taken, but is subsequently determined to have been mispredicted

### SUMMARY OF THE DISCLOSURE

Aspects disclosed in the detailed description include branch prediction based on Least-Recently-Used (LRU)-class linked list branch predictors. Related apparatus, methods, and computer-readable media are also disclosed. As used herein, “LRU-class” and “LRU indicator” refer to the use of a replacement policy (such as Least-Recently-Used or Pseudo-Least-Recently-Used, as non-limiting examples) that is premised upon allocating least-recently-used predictor entries rather than a most-recently-used predictor entry. In this regard, a branch predictor circuit is provided. The branch predictor circuit comprises branch direction prediction logic, and further comprises a linked list comprising a plurality of predictor entries, each of which comprises a link address register. The branch predictor circuit also comprises a LRU indicator indicative of a relative age of each of the plurality of predictor entries of the linked list. The branch predictor circuit is configured to detect a first branch instruction corresponding to a subroutine call in an instruction stream. The branch predictor circuit is further configured to determine whether the first branch instruction is predicted to be taken based on the branch direction prediction logic. The branch predictor circuit is also configured to, responsive to determining that the first branch instruction is predicted to be taken, allocate a first least-recently-used predictor entry of the plurality of predictor entries of the linked list based on the LRU indicator. The branch predictor circuit is also configured to, further responsive to determining that the first branch instruction is predicted to be taken, store a sequential address for the first branch instruction in the link address register of the first least-recently-used predictor entry. By allocating a least-recently-used predictor entry rather than a most-recently-used predictor entry, the branch predictor circuit may decrease sensitivity to speculative corruption compared to conventional stack-based branch predictors.

In another aspect, a branch predictor circuit is provided. The branch predictor circuit comprises a means for detecting a first branch instruction corresponding to a subroutine call in an instruction stream. The branch predictor circuit further comprises a means for determining whether the first branch instruction is predicted to be taken. The branch predictor circuit also comprises a means for, responsive to determining that the first branch instruction is predicted to be taken, allocating a first least-recently-used predictor entry of a plurality of predictor entries of a linked list based on a LRU indicator indicative of relative time since last use of the plurality of predictor entries of the linked list. The branch predictor circuit additionally comprises a means for, further responsive to determining that the first branch instruction is predicted to be taken, storing a sequential address for the first branch instruction in a link address register of the first least-recently-used predictor entry.

In another aspect, a method for providing branch prediction is provided. The method comprises detecting a first branch instruction corresponding to a subroutine call in an instruction stream. The method further comprises determining whether the first branch instruction is predicted to be taken. The method also comprises, responsive to determining that the first branch instruction is predicted to be taken, allocating a first least-recently-used predictor entry of a plurality of predictor entries of a linked list based on a LRU indicator indicative of relative time since last use of the plurality of predictor entries of the linked list. The method additionally comprises, further responsive to determining that the first branch instruction is predicted to be taken, storing a sequential address for the first branch instruction in a link address register of the first least-recently-used predictor entry.

In another aspect, a non-transitory computer-readable medium is provided, having stored thereon computer executable instructions to cause a processor to detect a first branch instruction corresponding to a subroutine call in an instruction stream. The computer-executable instructions further cause the processor to determine whether the first branch instruction is predicted to be taken. The computer-executable instructions also cause the processor to, responsive to determining that the first branch instruction is predicted to be taken, allocate a first least-recently-used predictor entry of a plurality of predictor entries of a linked list based on a LRU indicator indicative of relative time since last use of the plurality of predictor entries of the linked list. The computer-executable instructions additionally cause the processor to, further responsive to determining that the first branch instruction is predicted to be taken, store a sequential address for the first branch instruction in a link address register of the first least-recently-used predictor entry.

### BRIEF DESCRIPTION OF THE FIGURES

FIG. 1 is a block diagram of an exemplary computer processor including a branch predictor circuit configured to provide branch prediction using a Least-Recently-Used (LRU)-class linked list;

FIG. 2 is a block diagram illustrating exemplary elements of the branch predictor circuit of FIG. 1;

FIGS. 3A-3F are block diagrams illustrating use of the LRU-class linked list by the branch predictor circuit of FIG. 1 during branch prediction;

FIG. 4 is a flowchart illustrating exemplary operations of the branch predictor circuit of FIG. 1 for branch prediction using a LRU-class linked list;

FIG. 5 is a flowchart illustrating further exemplary operations of the branch predictor circuit of FIG. 1 for storing additional data for misprediction recovery;

FIG. 6 is a flowchart illustrating further exemplary operations of the branch predictor circuit of FIG. 1 for using the LRU-class linked list on a subroutine return;

FIG. 7 is a flowchart illustrating further exemplary operations of the branch predictor circuit of FIG. 1 for recovering from a mispredicted predicted-taken branch;

FIG. 8 is a flowchart illustrating further exemplary operations of the branch predictor circuit of FIG. 1 for recovering from a mispredicted predicted-not-taken subroutine call;

FIG. 9 is a flowchart illustrating further exemplary operations of the branch predictor circuit of FIG. 1 for recovering from a mispredicted predicted-not-taken subroutine return; and

FIG. 10 is a block diagram of an exemplary processor-based system that can include the branch predictor circuit of FIG. 1.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include branch prediction based on Least-Recently-Used (LRU)-class linked list branch predictors. Related apparatus, methods, and computer-readable media are also disclosed. As used herein, “LRU-class” and “LRU indicator” refer to the use of a replacement policy (such as Least-Recently-Used or Pseudo-Least-Recently-Used, as non-limiting examples) that is premised upon allocating least-recently-used predictor entries rather than a most-recently-used predictor entry. In this regard, a branch predictor circuit is provided. The branch predictor circuit comprises branch direction prediction logic, and further comprises a linked list comprising a plurality of predictor entries, each of which comprises a link address register. The branch predictor circuit also comprises a LRU indicator indicative of relative time since last use of the plurality of predictor entries of the linked list. The branch predictor circuit is configured to detect a first branch instruction corresponding to a subroutine call in an instruction stream. The branch predictor circuit is further configured to determine whether the first branch instruction is predicted to be taken based on the branch direction prediction logic. The branch predictor circuit is also configured to, responsive to determining that the first branch instruction is predicted to be taken, allocate a first least-recently-used predictor entry of the plurality of predictor entries of the linked list based on the LRU indicator. The branch predictor circuit is also configured to, further responsive to determining that the first branch instruction is predicted to be taken, store a sequential address for the first branch instruction in the link address register of the first least-recently-used predictor entry. By allocating a least-recently-used predictor entry rather than a most-recently-used predictor entry, the branch predictor circuit may decrease sensitivity to speculative corruption compared to conventional stack-based branch predictors.

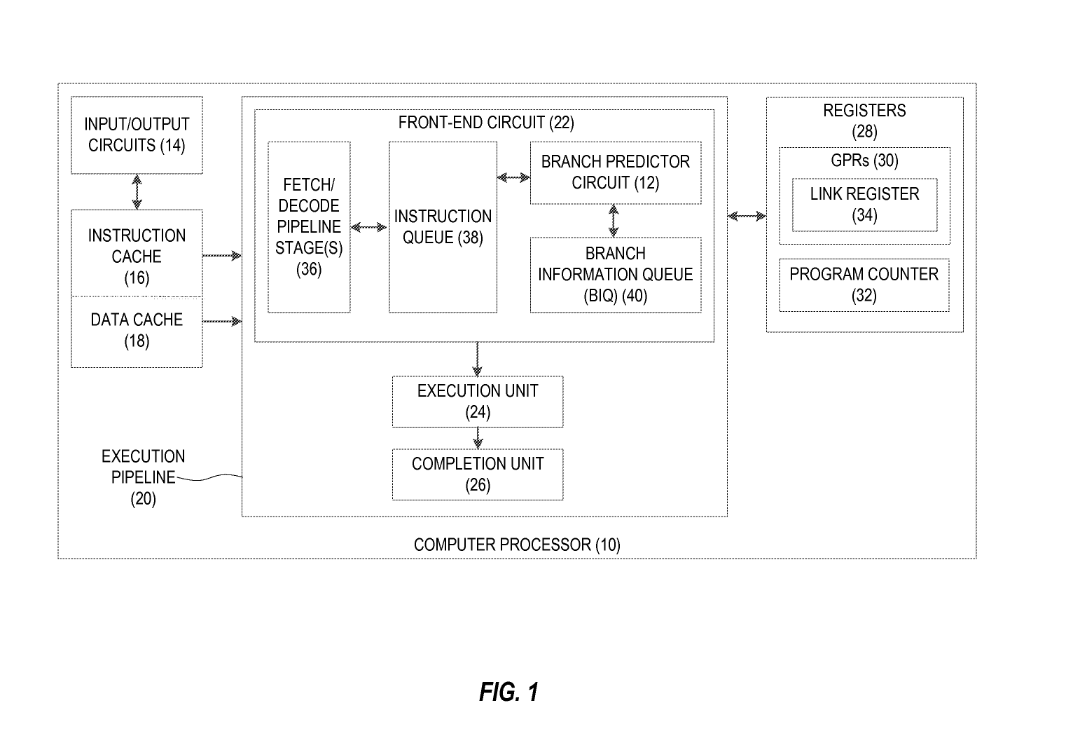

In this regard, FIG. 1 is a block diagram of an exemplary computer processor 10. The computer processor 10 includes a branch predictor circuit 12 that is configured to provide branch prediction using a LRU-class linked list, as disclosed herein. The computer processor 10 may encompass any one of known digital logic elements, semiconductor circuits, processing cores, and/or memory structures, among other elements, or combinations thereof. Aspects described herein are not restricted to any particular arrangement of elements, and the disclosed techniques may be easily extended to various structures and layouts on semiconductor dies or packages.

The computer processor 10 includes input/output circuits 14, an instruction cache 16, and a data cache 18. The computer processor 10 further comprises an execution pipeline 20, which includes a front-end circuit 22, an execution unit 24, and a completion unit 26. The computer processor 10 additionally includes registers 28, which comprise one or more general purpose registers (GPR) 30, a program counter 32, and a link register 34. In some aspects, such as those employing the ARM® ARM7™ architecture, the link register 34 is one of the GPRs 30, as shown in FIG. 1. Alternately, some aspects, such as those utilizing the IBM® PowerPC® architecture, may provide that the link register 34 is separate from the GPRs 30 (not shown).

In exemplary operation, the front-end circuit 22 of the execution pipeline 20 fetches instructions (not shown) from the instruction cache 16, which in some aspects may be an on chip Level 1 (L1) cache, as a non-limiting example. The fetched instructions are decoded by the front-end circuit 22 and issued to the execution unit 24. The execution unit 24 executes the issued instructions, and the completion unit 26 retires the executed instructions. In some aspects, the completion unit 26 may comprise a write-back mechanism that stores the execution results in one or more of the registers 28. It is to be understood that the execution unit 24 and/or the completion unit 26 may each comprise one or more sequential pipeline stages. It is to be further understood that instructions may be fetched and/or decoded in groups of more than one.

To improve performance, the computer processor 10 may employ branch prediction, the exemplary operation of which is now described. The front-end circuit 22 comprises one or more fetch/decode pipeline stages 36, which enable multiple instructions to be fetched and decoded concurrently. An instruction queue 38 for holding fetched instructions pending dispatch to the execution unit 24 is communicatively coupled to one or more of the fetch/decode pipeline stages 36. The instruction queue 38 is also communicatively coupled to the branch predictor circuit 12, which is configured to generate branch predictions (not shown) for conditional branch instructions that are encountered in the instruction queue 38. In the example of FIG. 1, the branch predictor circuit 12 is communicatively coupled to a branch information queue (BIQ) 40. The BIQ 40 may store additional information related to predicted branch instructions, such as data necessary to recover from a mispredicted branch, as a non-limiting example.

A conventional branch predictor circuit (not shown) may employ a stack to track branch return addresses for branch instructions that are predicted to be taken. The conventional branch predictor circuit may record a sequential address as a branch return address when a predicted-taken branch instruction corresponding to a subroutine call is observed (e.g., by using a PUSH operation to place the sequential address onto the stack). As used herein, the “sequential address” refers to an address of a next instruction following the predicted-taken branch instruction in program order. The conventional branch predictor circuit may later restore a recorded sequential address as a target address prediction when a predicted-taken branch instruction corresponding to a subroutine return is observed (e.g., by using a POP operation to remove the sequential address from the stack).

However, because the stack effectively stores the sequential address in the most-recently-used entry in the stack, the conventional branch predictor circuit may be susceptible to corruption arising from speculative call and return branches. For example, a first predicted-taken subroutine call branch instruction to a subroutine A, results in the sequential address for subroutine A being placed in the stack. Based on the predicted execution of instructions in subroutine A, a subroutine return branch instruction for subroutine A is eventually encountered, and the sequential address for subroutine A is removed from the stack. A second subroutine call branch instruction for a subroutine B, also predicted to be taken, then causes the sequential address for subroutine B to be placed in the stack. At this point, it is determined that the execution flow within subroutine A was mispredicted, and execution is rolled back to a point before the subroutine return branch instruction for subroutine A. When the subroutine return branch instruction for subroutine A is encountered in the corrected instruction stream, the sequential address for subroutine A is no longer available, as it has been removed from the stack and replaced with the sequential address for subroutine B. Likewise, the stack may be corrupted if the first subroutine call branch instruction to subroutine B is incorrectly predicted not to be taken.

In this regard, the branch predictor circuit 12 of FIG. 1 provides branch predictions using a LRU-class linked list to store sequential addresses for subroutine calls in the least-recently-used entry of the linked list, rather than the most-recently-used entry. The branch predictor circuit 12 may also provide operations for recovering from a mispredicted branch instruction (either a predicted-taken or predicted-not-taken instruction) by restoring the branch predictor circuit 12 to a state resulting from a correct prediction. The branch predictor circuit 12 may thus maintain the performance of a stack-based implementation while decreasing sensitivity to speculative corruption.

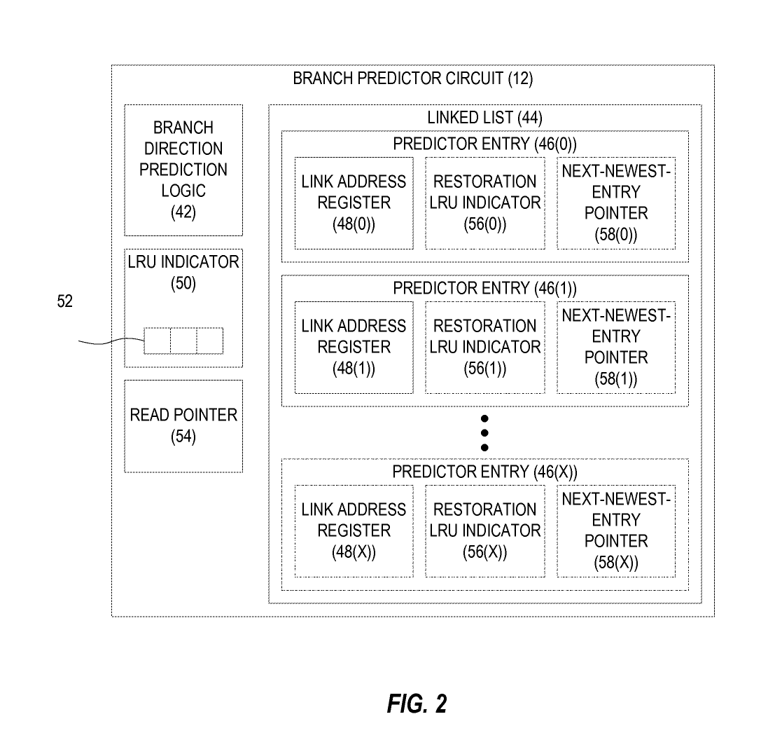

To illustrate exemplary elements of the branch predictor circuit 12 of FIG. 1, FIG. 2 is provided. As seen in FIG. 2, the branch predictor circuit 12 provides branch direction prediction logic 42, which may be based on branch prediction operations that are known in the art. The branch predictor circuit 12 further includes a linked list 44, which comprises a plurality of predictor entries 46. In the example of FIG. 2, the linked list 44 includes three predictor entries 46(0), 46(1), and 46(X). However, it is to be understood that, in some aspects of the branch predictor circuit 12, the linked list 44 may include more or fewer predictor entries 46 than shown in FIG. 2. Each of the predictor entries 46 of the linked list 44 may be used to track a return address for a branch instruction that is predicted to be taken by the branch direction prediction logic 42 of the branch predictor circuit 12. Accordingly, each of the predictor entries 46 of the linked list 44 includes a link address register 48 for storing a return address (not shown).

The branch predictor circuit 12 also includes a LRU indicator 50. The LRU indicator 50 is used by the branch predictor circuit 12 to track a relative age of each of the predictor entries 46 of the linked list 44, and to allocate a least-recently-used predictor entry 46 to store a sequential address for a predicted-taken branch instruction corresponding to a subroutine call. The LRU indicator 50 may be generated and updated according to LRU replacement policies (e.g., Least-Recently-Used or Pseudo-Least-Recently-Used, as non-limiting examples) known in the art. As a non-limiting example, the LRU indicator 50 may comprise a plurality of bits 52, each of which is indicative of a relative age of one of the plurality of predictor entries 46. For instance, in some aspects using a Pseudo-Least-Recently-Used replacement policy, each of the plurality of bits 52 of the LRU indicator 50 may represent a node in a binary tree for tracking a least-recently-used predictor entry 46 in the linked list 44. The value of each of the plurality of bits 52 indicates whether the branch predictor circuit 12 should follow a left branch or a right branch of the binary tree to identify the least-recently-used predictor entry 46. To locate a least-recently-used predictor entry 46, the branch predictor circuit 12 may traverse the binary tree according to the values of the plurality of bits 52.

The branch predictor circuit 12 further includes a read pointer 54. The read pointer 54 indicates a current read position among the predictor entries 46 in the linked list 44. When a branch instruction corresponding to a subroutine return is observed by the branch predictor circuit 12, the appropriate return address for the subroutine return branch instruction may be accessed by retrieving the return address from the link address register 48 of the predictor entry 46 indicated by the read pointer 54.

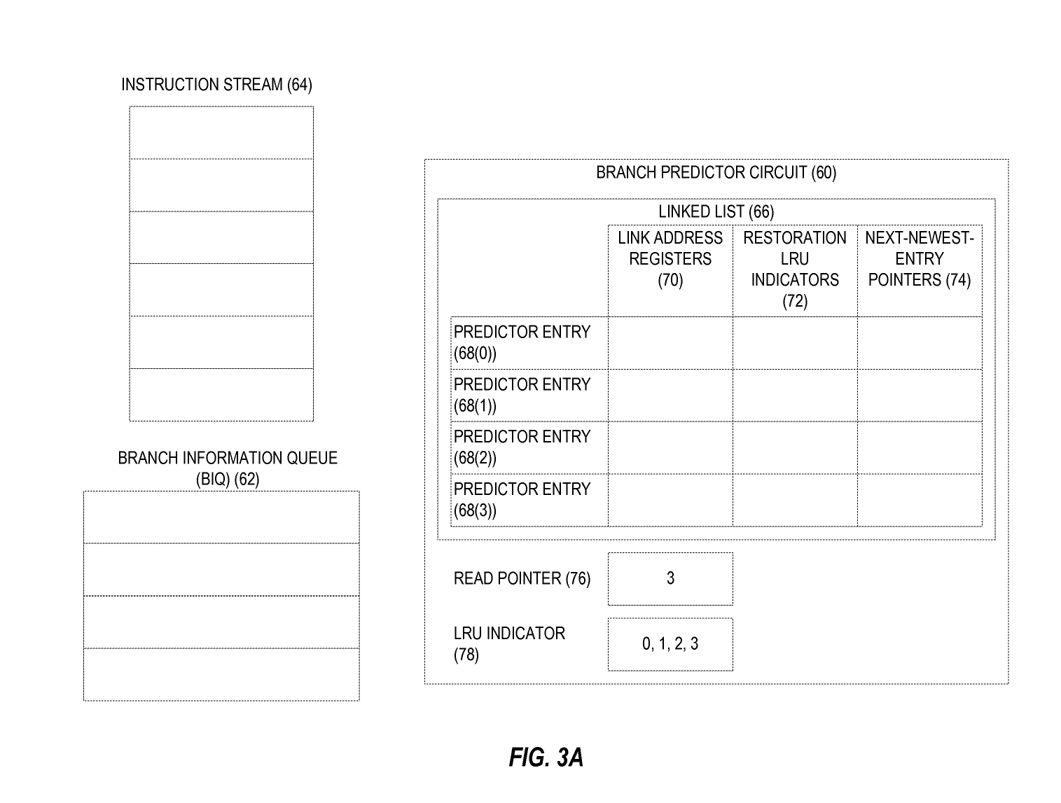

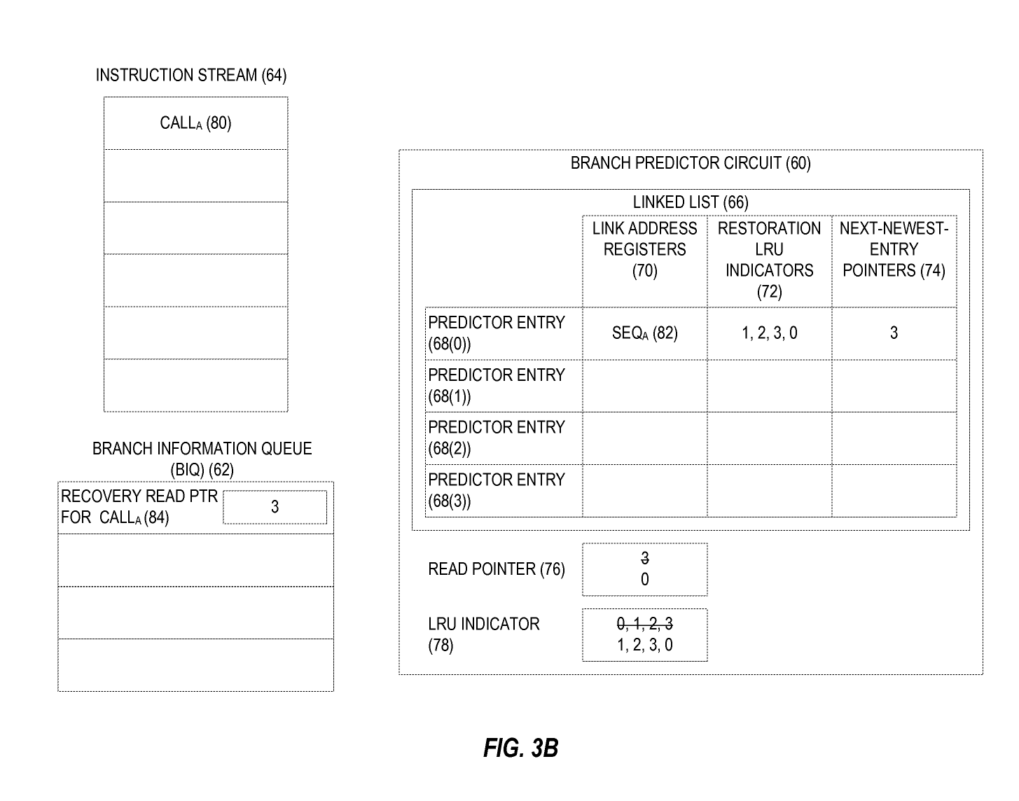

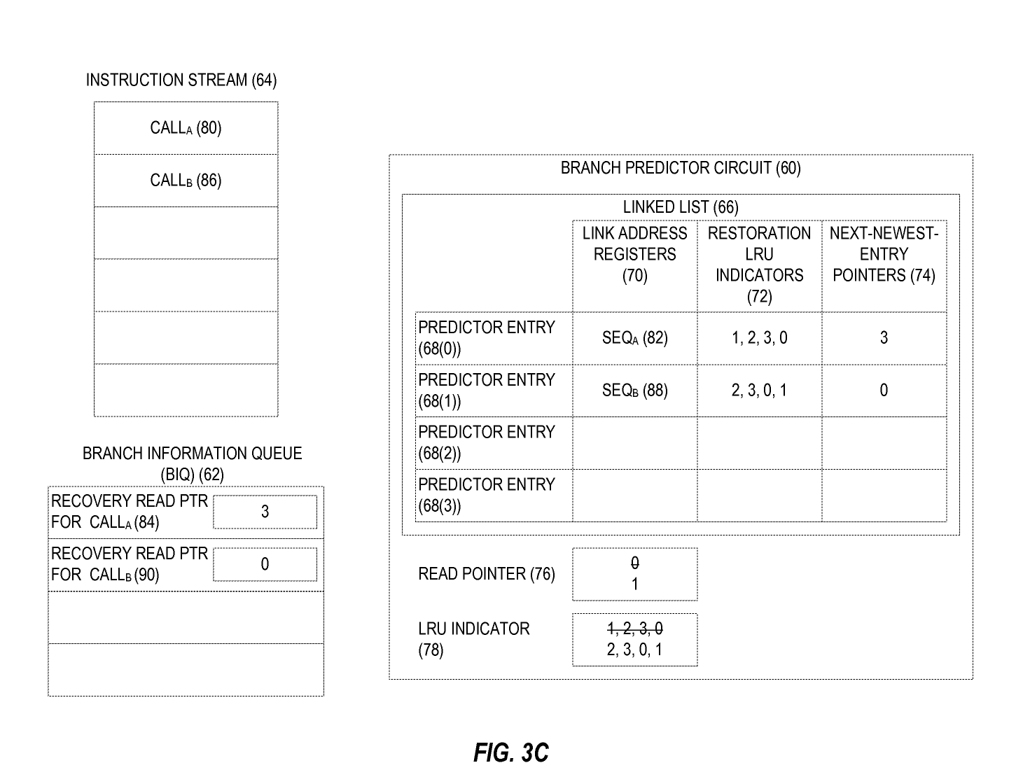

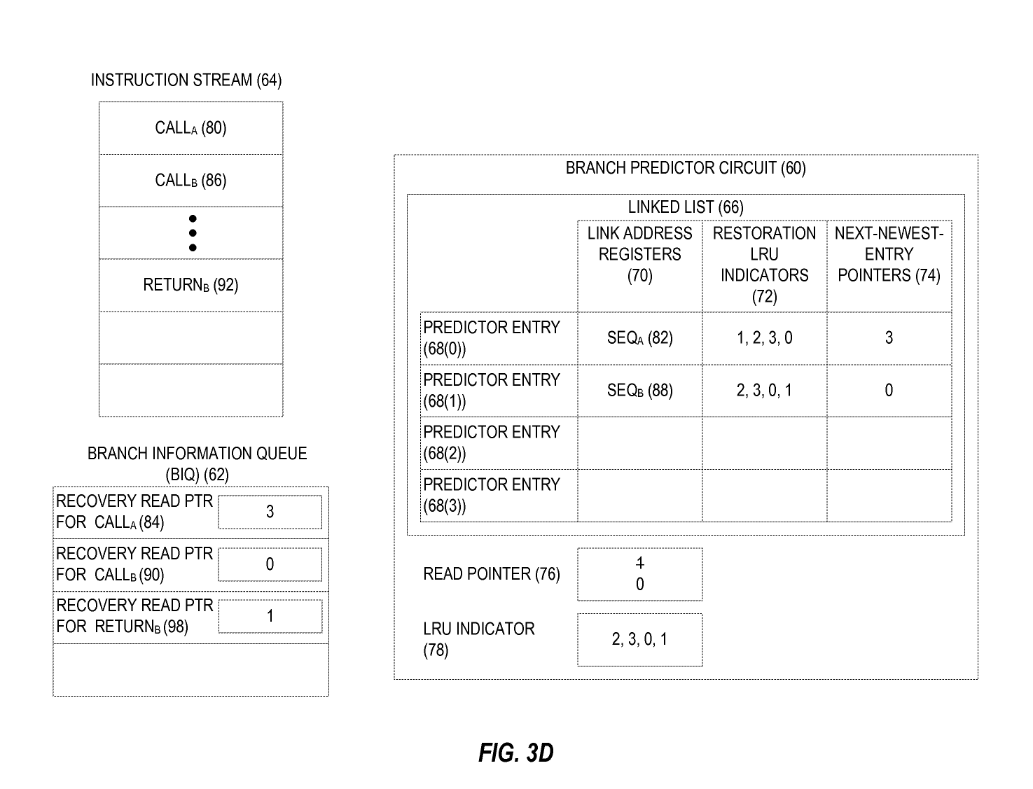

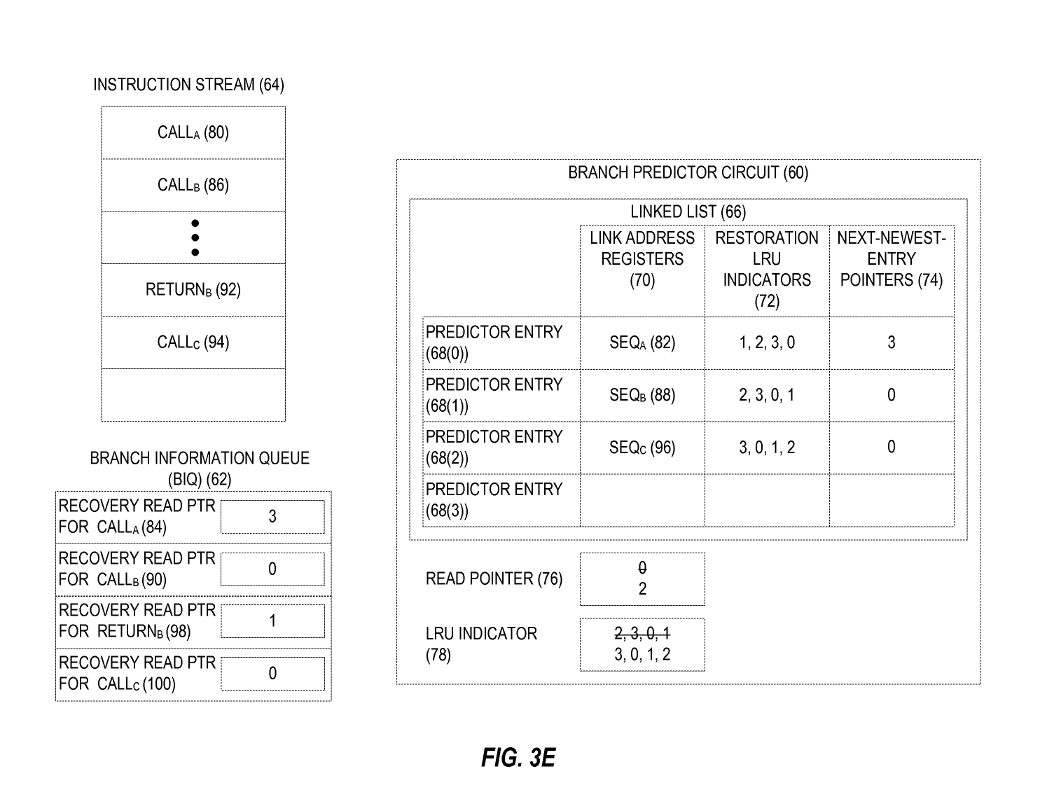

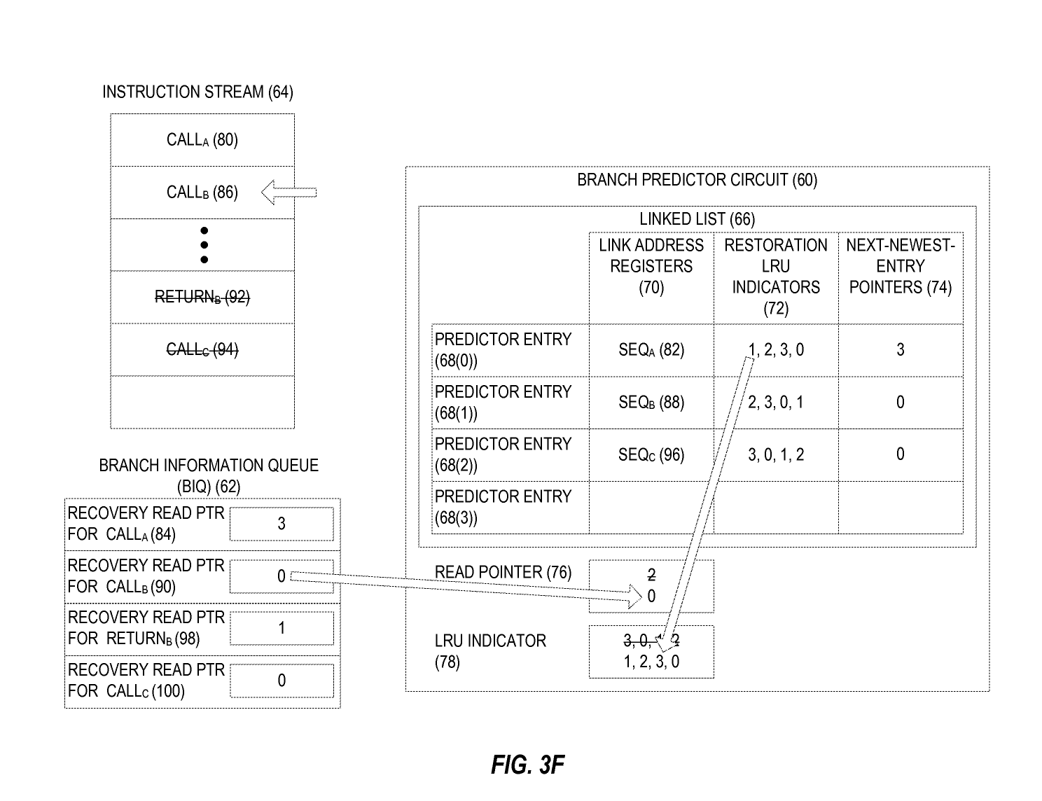

Some aspects of the branch predictor circuit 12 may provide that the predictor entries 46 include restoration LRU indicators 56. As discussed in greater detail below with respect to FIGS. 3A-3F, each of the restoration LRU indicators 56 may be used to store a current state of the LRU indicator 50 after allocation of a corresponding one of the predictor entries 46. The restoration LRU indicators 56 may subsequently be used by the branch predictor circuit 12 to restore a previous state of the LRU indicator 50 to recover from a mispredicted branch instruction. In some aspects, the branch predictor circuit 12 may further provide that the predictor entries 46 include next-newest-entry pointers 58. The next-newest-entry pointers 58 each point to a next-newest predictor entry among the predictor entries 46, and are used by the branch predictor circuit 12 to traverse the linked list 44, as further discussed below.

FIGS. 3A-3F are provided to illustrate the use of a LRU-class linked list by an exemplary branch predictor circuit 60 during branch prediction to recover from a mispredicted predicted-taken branch instruction (i.e., a branch instruction that is incorrectly predicted to be taken). It is to be understood that the branch predictor circuit 60 may correspond to aspects of the branch predictor circuit 12 of FIGS. 1 and 2. FIG. 3A shows the initial state of the branch predictor circuit 60 and a branch information queue (BIQ) 62 prior to beginning branch prediction for an instruction stream 64. In the example of FIG. 3A, the branch predictor circuit 60 includes a linked list 66 comprising four predictor entries 68(0), 68(1), 68(2), and 68(3). The predictor entries 68 include link address registers 70, restoration LRU indicators 72, and next-newest-entry pointers 74. The branch predictor circuit 60 further includes a read pointer 76 and a LRU indicator 78, functionality of which correspond to the functionality of the read pointer 54 and the LRU indicator 50, respectively, of FIG. 2. The read pointer 76 has an initial value of 3, indicating that the predictor entry 68(3) is at a current read position for the linked list 66. The LRU indicator 78 has an initial value of “0, 1, 2, 3” (i.e., the predictor entry 68(0) is the least-recently-used entry in the linked list 66, the predictor entries 68(1) and 68(2) are the next least recently used, and the predictor entry 68(3) is the most recently used among the predictor entries 68).

Referring now to FIG. 3B, a branch instruction 80, referred to herein as CALL_{A}, is detected by the branch predictor circuit 60 in the instruction stream 64. In this example, CALL_{A} corresponds to a subroutine call, and may comprise a branch-and-link instruction in some aspects. In this example, the branch predictor circuit 60 determines that CALL_{A} is predicted to be taken, and thus allocates the predictor entry 68(0) (i.e., the predictor entry 68 indicated as the least-recently-used entry by the LRU indicator 78) for use.

Upon allocation, the branch predictor circuit 60 stores a sequential address 82 for CALL_{A} (referred to in this example as SEQ_{A}) in the link address register 70 corresponding to the predictor entry 68(0). The branch predictor circuit 60 also stores the current value of the read pointer 76 (i.e., 3) as the next-newest-entry pointer 74 corresponding to the predictor entry 68(0). The LRU indicator 78 is updated to a value of “1, 2, 3, 0,” indicating that the predictor entry 68(1) is now the least-recently-used entry in the linked list 66, and the predictor entry 68(0) is the most-recently-used entry. After the LRU indicator 78 is updated, the branch predictor circuit 60 stores the value of the LRU indicator 78 as the restoration LRU indicator 72 corresponding to the predictor entry 68(0). The branch predictor circuit 60 stores the current value of the read pointer 76 in the BIQ 62 as the recovery read pointer 84 for CALL_{A}. The branch predictor circuit 60 then updates the read pointer 76 to point to the predictor entry 68(0) as the current read position for the linked list 66. These operations of the branch predictor circuit 60 may be considered analogous to a PUSH operation for a conventional stack, with the distinction that data is “pushed” into the least-recently-used entry rather than the most-recently-used entry.

Turning to FIG. 3C, a similar process is carried out by the branch predictor circuit 60 upon detection of a branch instruction 86, referred to herein as CALL_{B}, in the instruction stream 64. Like CALL_{A}, CALL_{B} corresponds to a subroutine call, and may be a branch-and-link instruction, as a non-limiting example. The branch predictor circuit 60 determines that CALL_{B} is predicted to be taken. According to the current value of the LRU indicator 78, the least-recently-used entry in the linked list 66 is the predictor entry 68(1). Thus, the branch predictor circuit 60 allocates the predictor entry 68(1) for use.

After allocation of the predictor entry 68(1), the branch predictor circuit 60 stores a sequential address 88 for CALL_{B} (referred to in this example as SEQ_{B}) in the link address register 70 corresponding to the predictor entry 68(1). The current value of the read pointer 76 (i.e., 0) is stored as the next-newest-entry pointer 74 corresponding to the predictor entry 68(1). The LRU indicator 78 is updated to a value of “2, 3, 0, 1” indicating that the predictor entry 68(2) is now the least-recently-used entry in the linked list 66, and the predictor entry 68(1) is the most-recently-used entry. The value of the LRU indicator 78 is then stored as the restoration LRU indicator 72 corresponding to the predictor entry 68(1). The branch predictor circuit 60 stores the current value of the read pointer 76 in the BIQ 62 as the recovery read pointer 90 for CALL_{B}, and then updates the read pointer 76 to point to the predictor entry 68(1) as the current read position for the linked list 66. Some aspects of the branch predictor circuit 60 may provide that the recovery read pointer 90 may further include an indicator (not shown) to indicate whether CALL_{B} was detected as, e.g., a PUSH operation or a POP operation.

In FIG. 3D, a number of instructions (not shown) following CALL_{B} in the instruction stream are processed. The branch predictor circuit 60 then detects a branch instruction 92 corresponding to a subroutine return of the subroutine call CALL_{B} (referred to herein as RETURN_{B}). Upon detecting RETURN_{B}, the branch predictor circuit 60 stores the current value of the read pointer 76 in the BIQ 62 as the recovery read pointer 98 for RETURN_{B}. In the example of FIG. 3D, RETURN_{B} is predicted to be taken. Accordingly, the branch predictor circuit 60 carries out operations that are analogous to a POP operation for a stack. The branch predictor circuit 60 first accesses the predictor entry 68 indicated by the read pointer 76 (in this example, the predictor entry 68(1)). The branch predictor circuit 60 retrieves the sequential address 88 stored in the link address register 70 corresponding to the predictor entry 68(1). The sequential address 88 may then be used as a predicted target address for RETURN_{B}. The branch predictor circuit 60 then updates the read pointer 76 to the value of the next-newest-entry pointer 74 corresponding to the predictor entry 68(1). After the read pointer 76 is updated, it indicates the predictor entry 68(0) as the current read position in the linked list 66.

Referring now to FIG. 3E, a branch instruction 94, referred to herein as CALL_{C}, is detected by the branch predictor circuit 60 in the instruction stream 64. Like CALL_{A} and CALL_{B}, CALL_{C} corresponds to a subroutine call, and may comprise a branch-and-link instruction in some aspects. After determining that CALL_{C} is predicted to be taken, the branch predictor circuit 60 allocates the predictor entry 68(2) (i.e., the predictor entry 68 indicated as the least-recently-used entry by the LRU indicator 78) for use. Note that this is in contrast to operation of a conventional stack, which in these circumstances would allocate the most-recently-used predictor entry (i.e., the predictor entry 68(1)) for use and consequently overwrite its contents.

Upon allocation, the branch predictor circuit 60 stores a sequential address 96 for CALL_{C} (referred to in this example as SEQ_{C}) in the link address register 70 corresponding to the predictor entry 68(2). The branch predictor circuit 60 also stores the current value of the read pointer 76 (i.e., 0) as the next-newest-entry pointer 74 corresponding to the predictor entry 68(2). The LRU indicator 78 is updated to a value of “3, 0, 1, 2,” indicating that the predictor entry 68(3) is now the least-recently-used entry in the linked list 66, and the predictor entry 68(2) is the most-recently-used entry. The branch predictor circuit 60 stores the updated value of the LRU indicator 78 as the restoration LRU indicator 72 corresponding to the predictor entry 68(2). The branch predictor circuit 60 stores the current value of the read pointer 76 in the BIQ 62 as the recovery read pointer 100 for CALL_{C}, and then updates the read pointer 76 to point to the predictor entry 68(2) as the current read position for the linked list 66.

Turning to FIG. 3F, the branch predictor circuit 60 now detects that CALL_{B} is a mispredicted predicted-taken branch instruction (referred to herein as “mispredicted predicted-taken branch instruction 86”). Because CALL_{B} preceded RETURN_{B} and CALL_{C} in the instruction stream 64, CALL_{B} and the instructions following CALL_{B} in the instruction stream 64, including RETURN_{B} and CALL_{C}, are purged from the processing pipeline, and the correct instructions are fetched. The branch predictor circuit 60 then restores itself back to the state it would have been in had CALL_{B} been correctly predicted. In this example, the restored state matches the state prior to CALL_{B} being mispredicted as a predicted-taken branch.

To accomplish this, the branch predictor circuit 60 retrieves the recovery read pointer 90 associated with CALL_{B}. In this example, the recovery read pointer 90 has a value of 0, indicating that the predictor entry 68(0) was the current read position within the linked list 66 prior to the misprediction of CALL_{B}. The branch predictor circuit 60 then updates the read pointer 76 with the value of the recovery read pointer 90, and accesses the predictor entry 68(0) to retrieve the value of the restoration LRU indicator 72 corresponding to the predictor entry 68(0). The LRU indicator 78 is then updated with the value “1, 2, 3, 0,” indicating that after the predictor entry 68(0) was allocated, the predictor entry 68(1) was the least-recently-used entry in the linked list 66. At this point, the state of the branch predictor circuit 60 has been effectively reset to the state it would have been in had CALL_{B} been correctly predicted. Processing of the instruction stream 64 then continues.

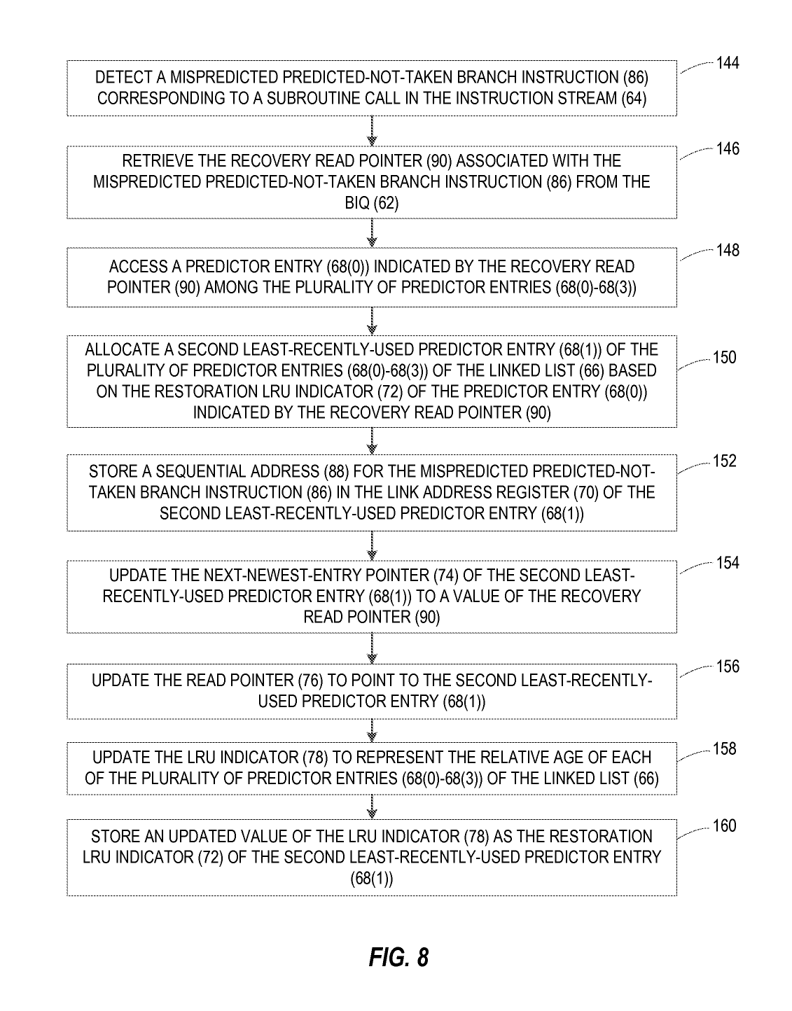

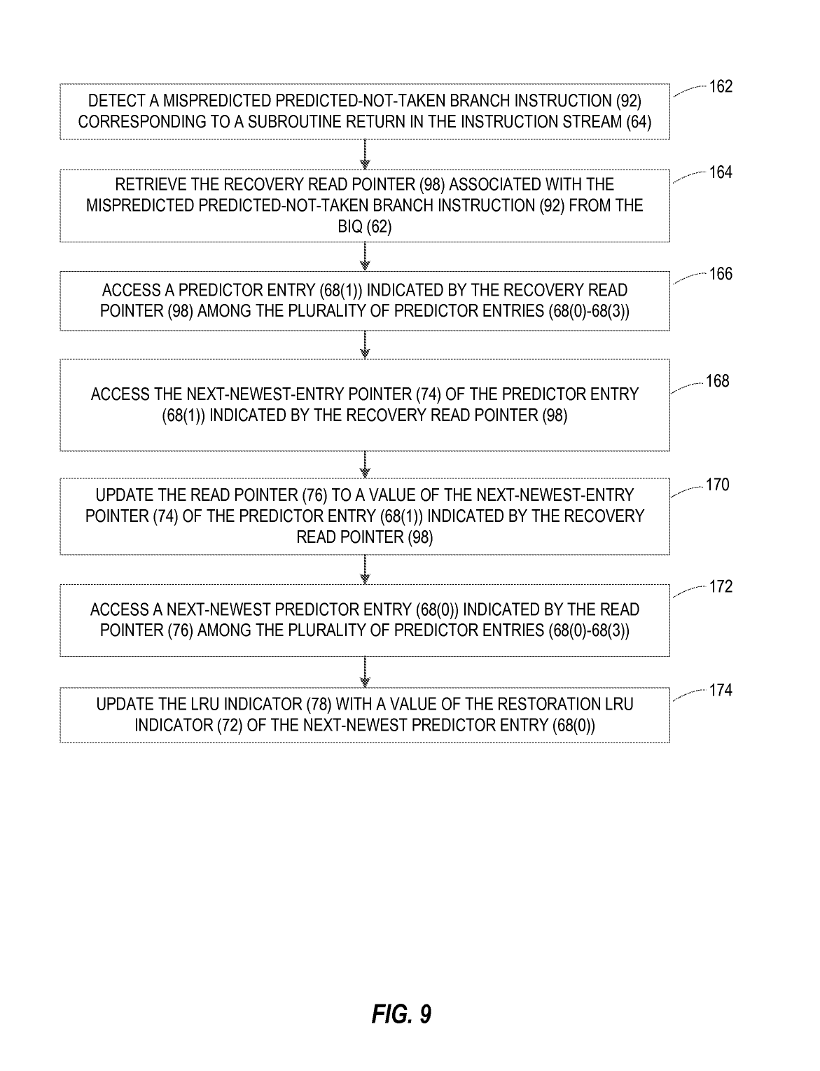

Note that in the example illustrated in FIGS. 3A-3F, the mispredicted branch instruction CALL_{B} is a mispredicted predicted-taken branch instruction (i.e., CALL_{B} was incorrectly predicted to be taken). Consequently, operations to restore the state of the branch predictor circuit 60 effectively reset the branch predictor circuit 60 to the state it would have been in had CALL_{B} not been taken. In some aspects in which a mispredicted predicted-not-taken branch instruction is detected (i.e., the mispredicted instruction was incorrectly predicted not to be taken), restoring the state of the branch predictor circuit 60 may comprise resetting the branch predictor circuit 60 to a state it would have been in had the mispredicted branch instruction been taken. For instance, exemplary operations for restoring the state of the branch predictor circuit 60 in the event of a mispredicted predicted-not-taken subroutine call and a mispredicted predicted-not-taken subroutine return are described in greater detail below with respect to FIGS. 8 and 9, respectively. Some aspects may provide that restoring the state of the branch predictor circuit 60 may be based on an indicator (not shown) stored in the BIQ 62 to indicate whether the mispredicted branch instruction was detected as, e.g., a PUSH operation or a POP operation.

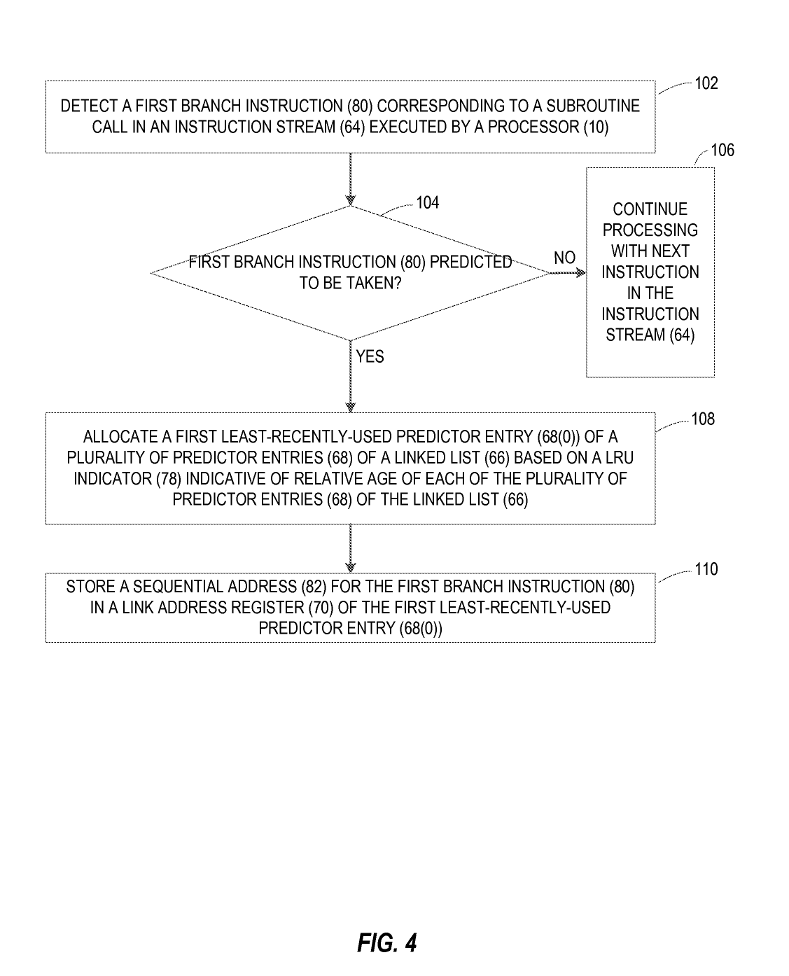

To illustrate exemplary operations for branch prediction using a LRU-class linked list branch predictor, FIG. 4 is provided. In describing the operations of FIG. 4, elements of FIGS. 1, 2, and 3A-3F are referenced for the sake of clarity. In FIG. 4, operations begin with the branch predictor circuit 12 of FIG. 1 detecting the first branch instruction 80 corresponding to a subroutine call in the instruction stream 64 executed by the computer processor 10 (block 102). As discussed above, in some aspects the first branch instruction 80 may comprise a branch-and-link instruction detected in the instruction stream 64.

The branch predictor circuit 12 determines whether the first branch instruction 80 is predicted to be taken (block 104). If not, processing continues with the next instruction in the instruction stream 64 (block 106). However, if the branch predictor circuit 12 determines at block 104 that the first branch instruction 80 is predicted to be taken, the branch predictor circuit 12 allocates a first least-recently-used predictor entry 68(0) of a plurality of predictor entries 68 of a linked list 66 based on a LRU indicator 78 indicative of a relative age of each of the plurality of predictor entries 68 of the linked list 66 (block 108). As noted above, some aspects may provide that the LRU indicator 78 comprises a plurality of bits 52, and may represent nodes of a binary tree each indicating a relative age of one of the predictor entries 68. The branch predictor circuit 12 then stores a sequential address 82 for the first branch instruction 80 in a link address register 70 of the first least-recently-used predictor entry 68(0) (block 110). By allocating a least-recently-used entry rather than a most-recently-used entry, the branch predictor circuit 12 may decrease sensitivity to speculative corruption.

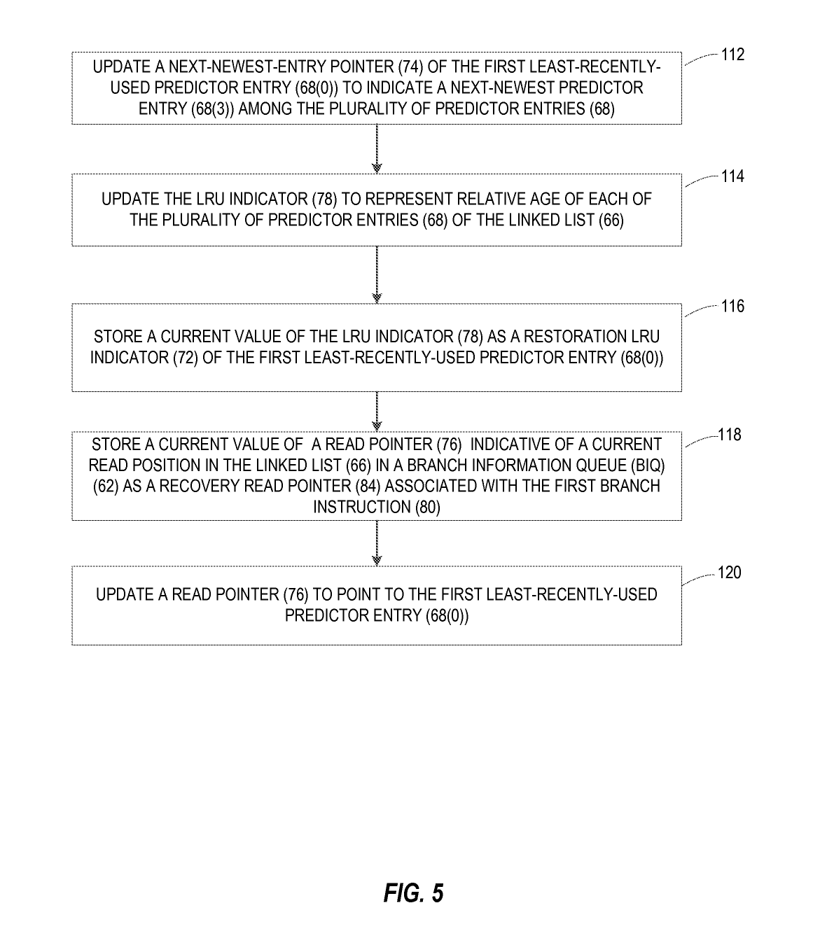

FIG. 5 illustrates further exemplary operations of the branch predictor circuit 12 of FIG. 1 for storing additional data for misprediction recovery. For the sake of clarity, elements of FIGS. 1, 2, and 3A-3F are referenced in describing FIG. 5. In some aspects, the operations of FIG. 5 may be performed by the branch predictor circuit 12 in addition to the operations of FIG. 4. In FIG. 5, operations begin with the branch predictor circuit 12 updating a next-newest-entry pointer 74 of the first least-recently-used predictor entry 68(0) to indicate a next-newest predictor entry 68(3) among the plurality of predictor entries 68 (block 112). In this manner, the branch predictor circuit 12 may traverse the predictor entries 68 of the linked list 66 by following the next-newest-entry pointers 74.

The branch predictor circuit 12 may update the LRU indicator 78 to represent a relative age of each of the plurality of predictor entries 68 of the linked list 66 (block 114). For example, the allocated predictor entry 68(0) may be indicated as the most-recently-used entry, while the next least-recently-used entry may be indicated by the LRU indicator 78. The branch predictor circuit 12 then stores an updated value of the LRU indicator 78 as a restoration LRU indicator 72 of the first least-recently-used predictor entry 68(0) (block 116). In some aspects, the restoration LRU indicator 72 may enable the branch predictor circuit 12 to restore a state of the branch predictor circuit 12 in the event of a mispredicted branch. The branch predictor circuit 12 stores a current value of the read pointer 76 indicative of a current read position in the linked list 66 in a branch information queue (BIQ) 62 as a recovery read pointer 84 associated with the first branch instruction 80 (block 118). The current value of the read pointer 76 may thus be available to the branch predictor circuit 12 for misprediction recovery. The branch predictor circuit 12 then updates the read pointer 76 to point to the first least-recently-used predictor entry 68(0) (block 118).

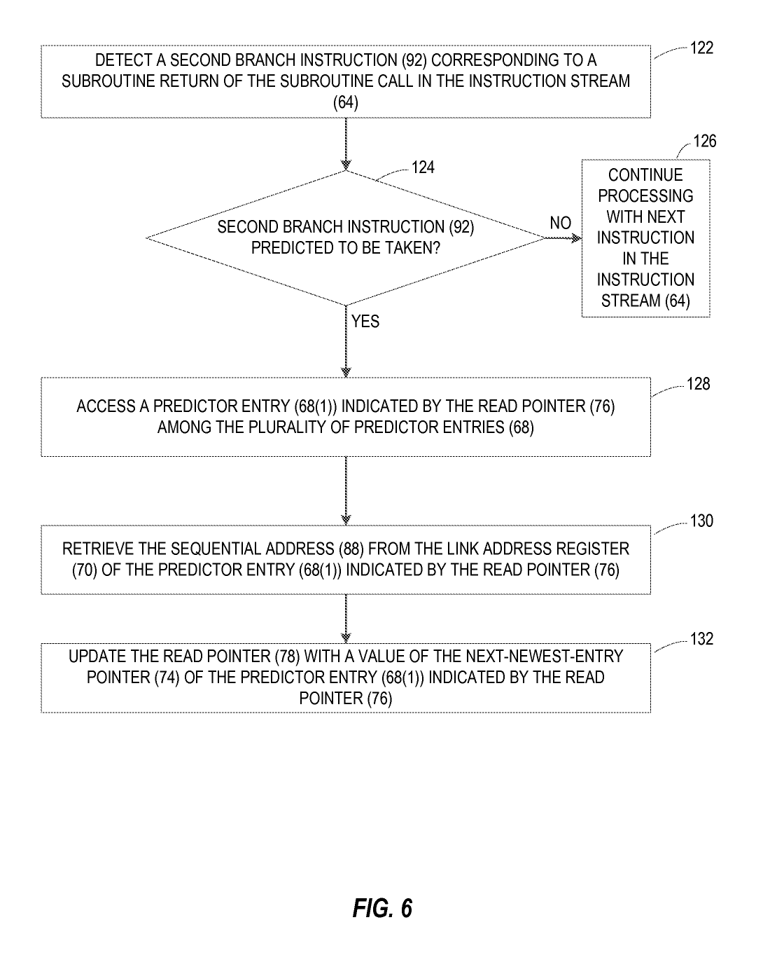

To illustrate further exemplary operations of the branch predictor circuit 12 for using the LRU-class linked list on a predicted-taken subroutine return, FIG. 6 is provided. Elements of FIGS. 1, 2, and 3A-3F are referenced in describing FIG. 6 for the sake of clarity. In FIG. 6, the branch predictor circuit 12 detects a second branch instruction 92 corresponding to a subroutine return of the subroutine call in the instruction stream 64 (block 122). In some aspects, the second branch instruction 92 may comprise a branch-to-link-register instruction detected in the instruction stream 64.

The branch predictor circuit 12 then determines whether the second branch instruction 92 is predicted to be taken (block 124). If not, processing continues with the next instruction in the instruction stream 64 (block 126). However, if the branch predictor circuit 12 determines at block 124 that the second branch instruction 92 will be taken, the branch predictor circuit 12 accesses the predictor entry 68(1) indicated by the read pointer 76 among the plurality of predictor entries 68 (block 128). The branch predictor circuit 12 retrieves the sequential address 88 from the link address register 70 of the predictor entry 68(1) indicated by the read pointer 76 (block 130). The sequential address 88 may then be used as a target address for the second branch instruction 92. The branch predictor circuit 12 then updates the read pointer 76 with a value of the next-newest-entry pointer 74 of the predictor entry 68(1) indicated by the read pointer 76 (block 132).

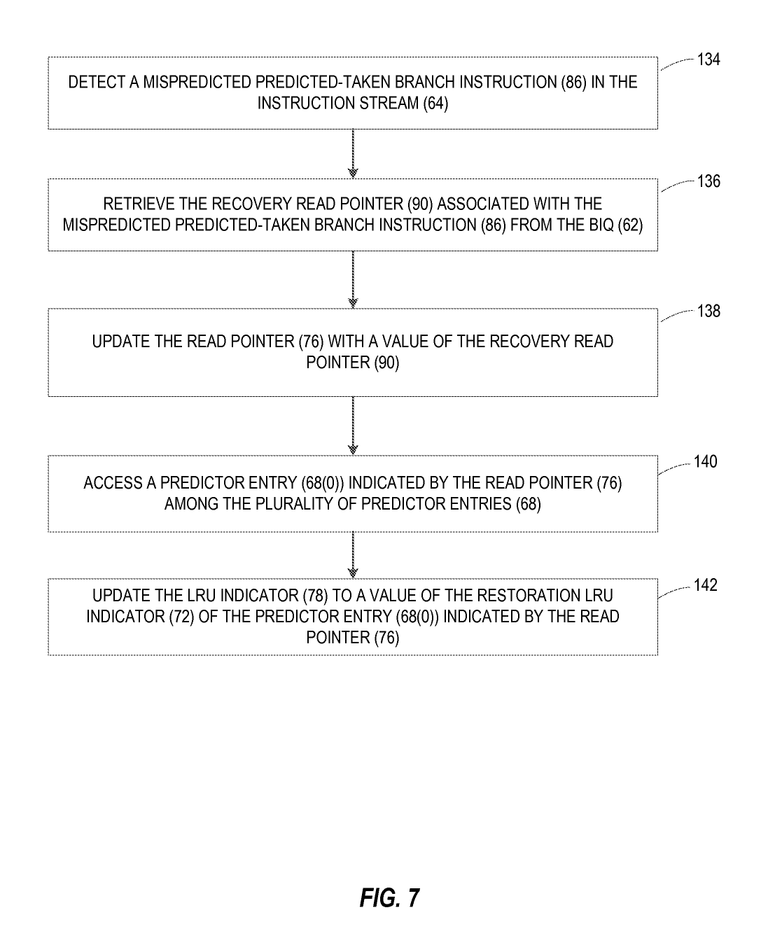

FIG. 7 is a flowchart illustrating further exemplary operations of the branch predictor circuit 12 of FIG. 1 for recovering from a mispredicted predicted-taken branch. It is to be understood that the operations illustrated by FIG. 7 correspond generally to the communications flows shown in FIG. 3F for restoring the state of the branch predictor circuit 60 to a state prior to the misprediction of the mispredicted predicted-taken branch instruction 86. In describing the operations of FIG. 7, elements of FIGS. 1, 2, and 3A-3F are referenced for the sake of clarity. In FIG. 7, operations begin with the branch predictor circuit 12 detecting a mispredicted predicted-taken branch instruction 86 in the instruction stream 64 (block 134). The branch predictor circuit 12 retrieves the recovery read pointer 90 associated with the mispredicted predicted-taken branch instruction 86 from the BIQ 62 (block 136). The branch predictor circuit 12 updates the read pointer 76 with a value of the recovery read pointer 90 (block 138). In this manner, the state of the read pointer 76 may be restored back to the state it would have been in had the mispredicted predicted-taken branch instruction 86 been predicted correctly. In this example, the restored state matches the state prior to the mispredicted predicted-taken branch instruction 86.

The branch predictor circuit 12 further may access a predictor entry 68(0) indicated by the read pointer 76 among the plurality of predictor entries 68 (block 140). The branch predictor circuit 12 then updates the LRU indicator 78 to a value of the restoration LRU indicator 72 of the predictor entry 68(0) indicated by the read pointer 76 (block 142). In this manner, the branch predictor circuit 12 may be restored back to the state it would have been in had the mispredicted predicted-taken branch instruction 86 been predicted correctly. In this example, the restored state matches that the state prior to the mispredicted predicted-taken branch instruction 86.

To illustrate exemplary operations of the branch predictor circuit 12 of FIG. 1 for recovering from a mispredicted predicted-not-taken subroutine call, FIG. 8 is provided. For the sake of clarity, elements of FIGS. 1, 2, and 3C are referenced in describing the operations of FIG. 8. The operations illustrated in FIG. 8 may be carried out in response to detection of a mispredicted subroutine call that was predicted not to be taken. For example, if CALL_{B} in FIG. 3C (referred to in this example as “mispredicted predicted-not-taken instruction 86”) had been incorrectly predicted not to be taken, the branch predictor circuit 60 of FIG. 3C may carry out the operations shown in FIG. 8 to restore the branch predictor circuit 60 to the state shown in FIG. 3C.

In FIG. 8, operations begin with the branch predictor circuit 12 detecting a mispredicted predicted-not-taken branch instruction 86 corresponding to a subroutine call in the instruction stream 64 (block 144). Upon detecting the mispredicted predicted-not-taken branch instruction 86, the branch predictor circuit 12 retrieves the recovery read pointer 90 associated with the mispredicted predicted-not-taken branch instruction 86 from the BIQ 62 (block 146). The branch predictor circuit 12 then accesses a predictor entry 68(0) indicated by the recovery read pointer 90 among the plurality of predictor entries 68(0)-68(3) (block 148).

The branch predictor circuit 12 next updates the linked list 66 to create an entry for the mispredicted predicted-not-taken branch instruction 86. The branch predictor circuit 12 allocates a second least-recently-used predictor entry 68(1) of the plurality of predictor entries 68(0)-68(3) of the linked list 66 based on the restoration LRU indicator 72 of the predictor entry 68(0) indicated by the recovery read pointer 90 (block 150). A sequential address 88 for the mispredicted predicted-not-taken branch instruction 86 is stored in the link address register 70 of the second least-recently-used predictor entry 68(1) (block 152). The branch predictor circuit 12 also updates the next-newest-entry pointer 74 of the second least-recently-used predictor entry 68(1) to a value of the recovery read pointer 90 (block 154).

The branch predictor circuit 12 then updates the read pointer 76 to point to the second least-recently-used predictor entry 68(1) (block 156). The LRU indicator 78 is updated to represent the relative age of each of the plurality of predictor entries 68(0)-68(3) of the linked list 66 (block 158). An updated value of the LRU indicator 78 is then stored as the restoration LRU indicator 72 of the second least-recently-used predictor entry 68(1) (block 160). At this point, the branch predictor circuit 12 has been restored to the state it would have been in had the mispredicted predicted-not-taken branch instruction 86 been predicted to be taken. Processing of the instruction stream 64 then continues.

FIG. 9 illustrates exemplary operations of the branch predictor circuit 12 of FIG. 1 for recovering from a mispredicted predicted-not-taken subroutine return. As a non-limiting example, if RETURN_{B} in FIG. 3D (referred to in this example as “mispredicted predicted-not-taken branch instruction 92”) had been incorrectly predicted not to be taken, the branch predictor circuit 60 of FIG. 3D may carry out the operations shown in FIG. 9 to restore the branch predictor circuit 60 to a state similar to that shown in FIG. 3D. For the sake of clarity, elements of FIGS. 1, 2, and 3D are referenced in describing the operations of FIG. 9.

Operations in FIG. 9 begin with the branch predictor circuit 12 detecting a mispredicted predicted-not-taken branch instruction 92 corresponding to a subroutine return in the instruction stream 64 (block 162). The branch predictor circuit 12 retrieves the recovery read pointer 98 associated with the mispredicted predicted-not-taken branch instruction 92 from the BIQ 62 (block 164). The branch predictor circuit 12 next accesses a predictor entry 68(1) indicated by the recovery read pointer 98 among the plurality of predictor entries 68(0)-68(3) (block 166).

The next-newest-entry pointer 74 of the predictor entry 68(1) indicated by the recovery read pointer 98 is then accessed by the branch predictor circuit 12 (block 168). The branch predictor circuit 12 then updates the read pointer 76 to a value of the next-newest-entry pointer 74 of the predictor entry 68(1) indicated by the recovery read pointer 98 (block 170). To restore the LRU indicator 78, the branch predictor circuit 12 accesses a next-newest predictor entry 68(0) indicated by the read pointer 76 among the plurality of predictor entries 68(0)-68(3) (block 172). The LRU indicator 78 is then updated with a value of the restoration LRU indicator 72 of the next-newest predictor entry 68(0) (block 174).

Branch prediction using a LRU-class linked list branch predictor according to aspects disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

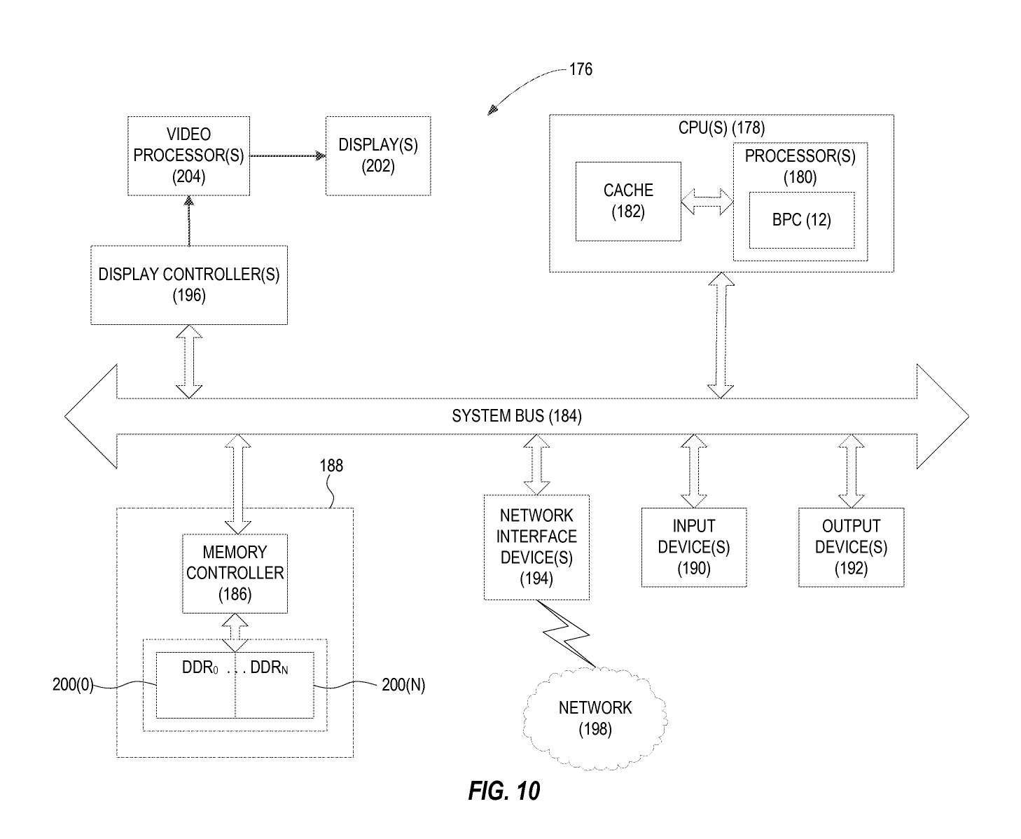

In this regard, FIG. 10 illustrates an example of a processor-based system 176 that can employ the branch predictor circuit 12 illustrated in FIGS. 1 and 2. In this example, the processor-based system 176 includes one or more central processing units (CPUs) 178, each including one or more processors 180. The one or more processors 180 may include the branch predictor circuit (BPC) 12 of FIGS. 1 and 2. The CPU(s) 178 may have cache memory 182 coupled to the processor(s) 180 for rapid access to temporarily stored data. The CPU(s) 178 is coupled to a system bus 184 and can intercouple master and slave devices included in the processor-based system 176. As is well known, the CPU(s) 178 communicates with these other devices by exchanging address, control, and data information over the system bus 184. For example, the CPU(s) 178 can communicate bus transaction requests to a memory controller 186 as an example of a slave device.

Other master and slave devices can be connected to the system bus 184. As illustrated in FIG. 10, these devices can include a memory system 188, one or more input devices 190, one or more output devices 192, one or more network interface devices 194, and one or more display controllers 196, as examples. The input device(s) 190 can include any type of input device, including but not limited to input keys, switches, voice processors, etc. The output device(s) 192 can include any type of output device, including but not limited to audio, video, other visual indicators, etc. The network interface device(s) 194 can be any devices configured to allow exchange of data to and from a network 198. The network 198 can be any type of network, including but not limited to a wired or wireless network, a private or public network, a wireless sensor network (WSN), a local area network (LAN), a wide local area network (WLAN), and/or the Internet. The network interface device(s) 194 can be configured to support any type of communications protocol desired. The memory system 188 can include one or more memory units 200(0-N).

The CPU(s) 178 may also be configured to access the display controller(s) 196 over the system bus 184 to control information sent to one or more displays 202. The display controller(s) 196 sends information to the display(s) 202 to be displayed via one or more video processors 204, which process the information to be displayed into a format suitable for the display(s) 202. The display(s) 202 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The master and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A branch predictor circuit comprising:
branch direction prediction logic;
a linked list comprising a plurality of predictor entries each comprising a link address register; and
a Least-Recently-Used (LRU) indicator indicative of a relative age of each of the plurality of predictor entries of the linked list;
the branch predictor circuit configured to:
detect a first branch instruction corresponding to a subroutine call in an instruction stream;
determine whether the first branch instruction is predicted to be taken based on the branch direction prediction logic; and
responsive to determining that the first branch instruction is predicted to be taken:
allocate a first least-recently-used predictor entry of the plurality of predictor entries of the linked list based on the LRU indicator; and
store a sequential address for the first branch instruction in the link address register of the first least-recently-used predictor entry.

2. The branch predictor circuit of claim 1, further comprising a read pointer indicative of a current read position in the linked list;
wherein the branch predictor circuit is communicatively coupled to a branch information queue (BIQ);
wherein each predictor entry of the plurality of predictor entries of the linked list further comprises:
a next-newest-entry pointer; and
a restoration LRU indicator;
wherein the branch predictor circuit is further configured to, responsive to determining that the first branch instruction is predicted to be taken:
update the next-newest-entry pointer of the first least-recently-used predictor entry to indicate a next-newest predictor entry among the plurality of predictor entries;
update the LRU indicator to represent the relative age of each of the plurality of predictor entries of the linked list;
store an updated value of the LRU indicator as the restoration LRU indicator of the first least-recently-used predictor entry;
store a current value of the read pointer in the BIQ as a recovery read pointer associated with the first branch instruction; and
update the read pointer to point to the first least-recently-used predictor entry.

3. The branch predictor circuit of claim 2, further configured to:
detect a second branch instruction corresponding to a subroutine return of the subroutine call in the instruction stream;
determine whether the second branch instruction is predicted to be taken based on the branch direction prediction logic; and
responsive to determining that the second branch instruction is predicted to be taken:
store the current value of the read pointer in the BIQ as a recovery read pointer associated with the second branch instruction;
access a predictor entry indicated by the read pointer among the plurality of predictor entries;
retrieve the sequential address from the link address register of the predictor entry indicated by the read pointer; and
update the read pointer with a value of the next-newest-entry pointer of the predictor entry indicated by the read pointer.

4. The branch predictor circuit of claim 2, further configured to:
detect a mispredicted branch instruction in the instruction stream; and
responsive to detecting the mispredicted branch instruction:
retrieve the recovery read pointer associated with the mispredicted branch instruction from the BIQ;
update the read pointer with a value of the recovery read pointer;
access a predictor entry indicated by the read pointer among the plurality of predictor entries; and
update the LRU indicator to a value of the restoration LRU indicator of the predictor entry indicated by the read pointer.

5. The branch predictor circuit of claim 2, further configured to:
detect a mispredicted predicted-not-taken branch instruction corresponding to a subroutine call in the instruction stream; and
responsive to detecting the mispredicted predicted-not-taken branch instruction:
retrieve the recovery read pointer associated with the mispredicted predicted-not-taken branch instruction from the BIQ;
access a predictor entry indicated by the recovery read pointer among the plurality of predictor entries;
allocate a second least-recently-used predictor entry of the plurality of predictor entries of the linked list based on the restoration LRU indicator of the predictor entry indicated by the recovery read pointer;
store a sequential address for the mispredicted predicted-not-taken branch instruction in the link address register of the second least-recently-used predictor entry;
update the next-newest-entry pointer of the second least-recently-used predictor entry to the current value of the recovery read pointer;
update the read pointer to point to the second least-recently-used predictor entry;
update the LRU indicator to represent the relative age of each of the plurality of predictor entries of the linked list; and
store the updated value of the LRU indicator as the restoration LRU indicator of the second least-recently-used predictor entry.

6. The branch predictor circuit of claim 2, further configured to:
detect a mispredicted predicted-not-taken branch instruction corresponding to a subroutine return in the instruction stream; and
responsive to detecting the mispredicted predicted-not-taken branch instruction:
retrieve the recovery read pointer associated with the mispredicted predicted-not-taken branch instruction from the BIQ;
access a predictor entry indicated by the recovery read pointer among the plurality of predictor entries;
access the next-newest-entry pointer of the predictor entry indicated by the recovery read pointer;
update the read pointer to a value of the next-newest-entry pointer of the predictor entry indicated by the recovery read pointer;
access a next-newest predictor entry indicated by the read pointer among the plurality of predictor entries; and
update the LRU indicator with a value of the restoration LRU indicator of the next-newest predictor entry.

7. The branch predictor circuit of claim 1, wherein the LRU indicator comprises a plurality of bits each indicative of the relative age of one of the plurality of predictor entries.

8. The branch predictor circuit of claim 1 integrated into an integrated circuit (IC).

9. The branch predictor circuit of claim 1 integrated into a device selected from the group consisting of a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

10. A branch predictor circuit, comprising:
a means for detecting a first branch instruction corresponding to a subroutine call in an instruction stream;
a means for determining whether the first branch instruction is predicted to be taken;
a means for, responsive to determining that the first branch instruction is predicted to be taken, allocating a first least-recently-used predictor entry of a plurality of predictor entries of a linked list based on a Least-Recently-Used (LRU) indicator indicative of a relative age of each of the plurality of predictor entries of the linked list; and
a means for, further responsive to determining that the first branch instruction is predicted to be taken, storing a sequential address for the first branch instruction in a link address register of the first least-recently-used predictor entry.

11. A method for providing branch prediction, comprising:
detecting a first branch instruction corresponding to a subroutine call in an instruction stream;
determining whether the first branch instruction is predicted to be taken; and
responsive to determining that the first branch instruction is predicted to be taken:
allocating a first least-recently-used predictor entry of a plurality of predictor entries of a linked list based on a Least-Recently-Used (LRU) indicator indicative of a relative age of each of the plurality of predictor entries of the linked list; and
storing a sequential address for the first branch instruction in a link address register of the first least-recently-used predictor entry.

12. The method of claim 11, further comprising, responsive to determining that the first branch instruction is predicted to be taken:
updating a next-newest-entry pointer of the first least-recently-used predictor entry to indicate a next-newest predictor entry among the plurality of predictor entries;
updating the LRU indicator to represent the relative age of each of the plurality of predictor entries of the linked list;
storing an updated value of the LRU indicator as a restoration LRU indicator of the first least-recently-used predictor entry;
storing a current value of a read pointer indicative of a current read position in the linked list in a branch information queue (BIQ) as a recovery read pointer associated with the first branch instruction; and
updating the read pointer to point to the first least-recently-used predictor entry.

13. The method of claim 12, further comprising:
detecting a second branch instruction corresponding to a subroutine return of the subroutine call in the instruction stream;
determining whether the second branch instruction is predicted to be taken; and
responsive to determining that the second branch instruction is predicted to be taken:
accessing a predictor entry indicated by the read pointer among the plurality of predictor entries;
retrieving the sequential address from the link address register of the predictor entry indicated by the read pointer; and
updating the read pointer with a value of the next-newest-entry pointer of the predictor entry indicated by the read pointer.

14. The method of claim 12, further comprising:
detecting a mispredicted branch instruction in the instruction stream; and
responsive to detecting the mispredicted branch instruction:
retrieving the recovery read pointer associated with the mispredicted branch instruction from the BIQ;
updating the read pointer with a value of the recovery read pointer;
accessing a predictor entry indicated by the read pointer among the plurality of predictor entries; and
updating the LRU indicator to a value of the restoration LRU indicator of the predictor entry indicated by the read pointer.

15. The method of claim 12, further comprising:
detecting a mispredicted predicted-not-taken branch instruction corresponding to a subroutine call in the instruction stream; and
responsive to detecting the mispredicted predicted-not-taken branch instruction:
retrieving the recovery read pointer associated with the mispredicted predicted-not-taken branch instruction from the BIQ;
accessing a predictor entry indicated by the recovery read pointer among the plurality of predictor entries;
allocating a second least-recently-used predictor entry of the plurality of predictor entries of the linked list based on the restoration LRU indicator of the predictor entry indicated by the recovery read pointer;
storing a sequential address for the mispredicted predicted-not-taken branch instruction in the link address register of the second least-recently-used predictor entry;
updating the next-newest-entry pointer of the second least-recently-used predictor entry to a value of the recovery read pointer;
updating the read pointer to point to the second least-recently-used predictor entry;
updating the LRU indicator to represent the relative age of each of the plurality of predictor entries of the linked list; and
storing the updated value of the LRU indicator as the restoration LRU indicator of the second least-recently-used predictor entry.

16. The method of claim 12, further comprising:
detecting a mispredicted predicted-not-taken branch instruction corresponding to a subroutine return in the instruction stream; and
responsive to detecting the mispredicted predicted-not-taken branch instruction:
retrieving the recovery read pointer associated with the mispredicted predicted-not-taken branch instruction from the BIQ;
accessing a predictor entry indicated by the recovery read pointer among the plurality of predictor entries;
accessing the next-newest-entry pointer of the predictor entry indicated by the recovery read pointer;
updating the read pointer to a value of the next-newest-entry pointer of the predictor entry indicated by the recovery read pointer;
accessing a next-newest predictor entry indicated by the read pointer among the plurality of predictor entries; and
updating the LRU indicator with a value of the restoration LRU indicator of the next-newest predictor entry.

17. The method of claim 11, wherein the LRU indicator comprises a plurality of bits each indicative of the relative age of one of the plurality of predictor entries.

18. A non-transitory computer-readable medium having stored thereon computer-executable instructions to cause a processor to:
detect a first branch instruction corresponding to a subroutine call in an instruction stream;
determine whether the first branch instruction is predicted to be taken; and
responsive to determining that the first branch instruction is predicted to be taken:
allocate a first least-recently-used predictor entry of a plurality of predictor entries of a linked list based on a Least-Recently-Used (LRU) indicator indicative of a relative age of each of the plurality of predictor entries of the linked list; and
store a sequential address for the first branch instruction in a link address register of the first least-recently-used predictor entry.

19. The non-transitory computer-readable medium of claim 18 having stored thereon computer-executable instructions to further cause the processor to, responsive to determining that the first branch instruction is predicted to be taken:
update a next-newest-entry pointer of the first least-recently-used predictor entry to indicate a next-newest predictor entry among the plurality of predictor entries;
update the LRU indicator to represent the relative age of each of the plurality of predictor entries of the linked list;
store an updated value of the LRU indicator as a restoration LRU indicator of the first least-recently-used predictor entry;
store a current value of a read pointer indicative of a current read position in the linked list in a branch information queue (BIQ) as a recovery read pointer associated with the first branch instruction; and
update the read pointer to point to the first least-recently-used predictor entry.

20. The non-transitory computer-readable medium of claim 19 having stored thereon computer-executable instructions to further cause the processor to:
detect a second branch instruction corresponding to a subroutine return of the subroutine call in the instruction stream;
determine whether the second branch instruction is predicted to be taken; and
responsive to determining that the second branch instruction is predicted to be taken:
access a predictor entry indicated by the read pointer among the plurality of predictor entries;
retrieve the sequential address from the link address register of the predictor entry indicated by the read pointer; and
update the read pointer with a value of the next-newest-entry pointer of the predictor entry indicated by the read pointer.

21. The non-transitory computer-readable medium of claim 19 having stored thereon the computer-executable instructions to further cause the processor to:
detect a mispredicted branch instruction in the instruction stream; and
responsive to detecting the mispredicted branch instruction:
retrieve the recovery read pointer associated the mispredicted branch instruction from the BIQ;
update the read pointer with a value of the recovery read pointer;
access a predictor entry indicated by the read pointer among the plurality of predictor entries; and
update the LRU indicator to a value of the restoration LRU indicator of the predictor entry indicated by the read pointer.

22. The non-transitory computer-readable medium of claim 19 having stored thereon computer-executable instructions to further cause the processor to:
detect a mispredicted predicted-not-taken branch instruction corresponding to a subroutine call in the instruction stream; and
responsive to detecting the mispredicted predicted-not-taken branch instruction:
retrieve the recovery read pointer associated with the mispredicted predicted-not-taken branch instruction from the BIQ;
access a predictor entry indicated by the recovery read pointer among the plurality of predictor entries;
allocate a second least-recently-used predictor entry of the plurality of predictor entries of the linked list based on the restoration LRU indicator of the predictor entry indicated by the recovery read pointer;
store a sequential address for the mispredicted predicted-not-taken branch instruction in the link address register of the second least-recently-used predictor entry;
update the next-newest-entry pointer of the second least-recently-used predictor entry to a value of the recovery read pointer;
update the read pointer to point to the second least-recently-used predictor entry;
update the LRU indicator to represent the relative age of each of the plurality of predictor entries of the linked list; and
store the updated value of the LRU indicator as the restoration LRU indicator of the second least-recently-used predictor entry.

23. The non-transitory computer-readable medium of claim 19 having stored thereon computer-executable instructions to further cause the processor to:
detect a mispredicted predicted-not-taken branch instruction corresponding to a subroutine return in the instruction stream; and
responsive to detecting the mispredicted predicted-not-taken branch instruction:
retrieve the recovery read pointer associated with the mispredicted predicted-not-taken branch instruction from the BIQ;
access a predictor entry indicated by the recovery read pointer among the plurality of predictor entries;
access the next-newest-entry pointer of the predictor entry indicated by the recovery read pointer;
update the read pointer to a value of the next-newest-entry pointer of the predictor entry indicated by the recovery read pointer;
access a next-newest predictor entry indicated by the read pointer among the plurality of predictor entries; and
update the LRU indicator with a value of the restoration LRU indicator of the next-newest predictor entry.
